(19) United States
(12) Patent Application Publication
(10) Pub. No.: US 2023/0292659 A1
(43) Pub. Date: Sep. 21, 2023

(54) WORK MACHINE

(71) Applicant: HONDA MOTOR CO., LTD., Tokyo (JP)

(72) Inventors: Takuya MITO, Wako-shi (JP); Sei WATANABE, Wako-shi (JP); Noboru KAWAGUCHI, Wako-shi (JP); Kenichi TOYA, Wako-shi (JP); Shohei MASUDA, Wako-shi (JP)

(21) Appl. No.: 18/119,956

(22) Filed: Mar. 10, 2023

(30) Foreign Application Priority Data
Mar. 18, 2022 (JP) 2022-044240

(51) Int. Cl. A01D 34/68; A01D 43/063; A01D 34/81; A01D 34/74; A01D 34/00

(52) U.S. Cl. CPC A01D 34/68; A01D 43/0636; A01D 34/81; A01D 34/74; A01D 34/006; A01D 2101/00

(57) ABSTRACT

A work machine includes a power source, a rotation shaft that is rotated by power of the power source, a cutter blade that is rotated by the rotation shaft to cut a plant on the ground, and a housing that houses the cutter blade and has an opening through which the cutter blade is exposed to the ground. The housing has a charging port through which an object to be cut is charged to the cutter blade.

### CROSS-REFERENCE TO RELATED APPLICATION(S)

This application claims priority to and the benefit of Japanese Patent Application No. 2022-044240 filed on Mar. 18, 2022, the entire disclosure of which is incorporated herein by reference.

### BACKGROUND OF THE INVENTION

### Field of the Invention

The present invention relates to a work machine.

### Description of the Related Art

Conventionally, there has been known a lawn mower including a cutter blade that is rotated by the power of a power source and cuts lawn grass, a body portion having a housing that houses the cutter blade, and a mowed lawn container, and discharging a mowed lawn cut by the cutter blade from the housing to the mowed lawn container (for example, Japanese Patent Laid-Open No. 2020-156447). Typically, the mowed lawn in the mowed lawn container is scattered to the root of lawn grass to be utilized as a fertilizer for the lawn grass. Thereafter, the mowed lawn is decomposed by microorganisms or the like. Such a method of disposing of the mowed lawn is called mulching.

However, when plants such as a mowed lawn and weeds whose lengths remain long are scattered on the lawn grass, the decomposition of the mowed lawn by microorganisms is delayed, and undecomposed plant bodies are generated. The undecomposed plant bodies have various adverse effects on the growth of lawn grass. Thus, in the technique of Japanese Patent Laid-Open No. 2020-156447, it is difficult to further chop plants such as a mowed lawn cut by the cutter blade or the like.

### SUMMARY OF THE INVENTION

The present invention has an object to provide a technique for chopping an object to be cut that is difficult to chop.

According to an aspect of the present invention, there is provided a work machine comprising: a power source; a rotation shaft that is rotated by power of the power source; a cutter blade that is rotated by the rotation shaft to cut a plant on the ground; and a housing that houses the cutter blade and has an opening through which the cutter blade is exposed to the ground, wherein the housing has a charging port through which an object to be cut is charged to the cutter blade.

Further features of the present invention will become apparent from the following description of exemplary embodiments (with reference to the attached drawings).

### BRIEF DESCRIPTION OF THE DRAWINGS

FIG. 1 is a perspective view of a work machine according to an embodiment of the present invention;

FIG. 2 is a side view of a work machine according to an embodiment of the present invention;

FIG. 3 is a bottom view of a work machine according to an embodiment of the present invention;

FIG. 4 is a left side view of a height adjustment mechanism of a work machine according to an embodiment of the present invention;

FIG. 5 is an enlarged cross-sectional view of a housing according to an embodiment of the present invention;

FIG. 6 is an enlarged cross-sectional view of a housing according to an embodiment of the present invention;

FIG. 7 is a block diagram illustrating a functional configuration example of a work machine according to an embodiment of the present invention;

FIG. 8 is a flowchart for explaining an operation of the work machine based on selection of a work mode; and

FIG. 9 is a flowchart for explaining an operation of the work machine based on a detection result of a sensor unit.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

<Outline of Work Machine>

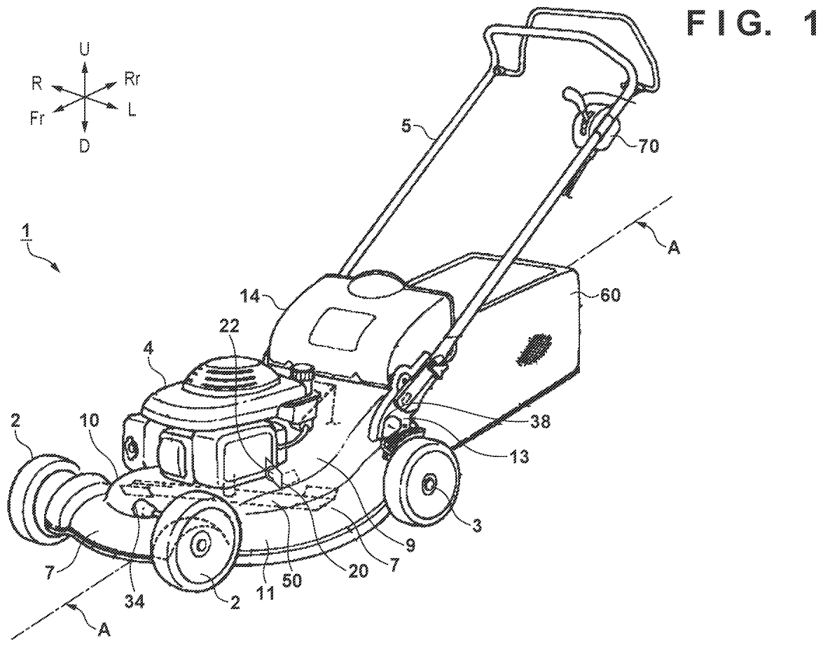

FIG. 1 is a perspective view of a work machine according to an embodiment of the present invention. A work machine 1 is a work machine that performs work while moving in a work field (for example, grass and lawn), and is, for example, a lawn mower. The work refers to work of cutting plants on the ground. Each of the front, rear, left, right, and upward and downward directions is defined so as to correspond to a direction viewed from an operator. In FIG. 1, a front side of the work machine 1 is denoted by Fr, a rear side thereof is denoted by Rr, a left side thereof is denoted by L, a right side thereof is denoted by R, an upper side thereof is denoted by U, and a lower side thereof is denoted by D.

The work machine 1 includes a body portion 10 as a machine body, a pair of left and right front wheels 2 disposed at a front portion of the body portion 10, a pair of left and right rear wheels 3 (only the left is illustrated in FIG. 1) disposed at a rear portion of the body portion 10, an engine 4 as a power source disposed at an upper portion of the body portion 10, and an operation handle 5 extending upward and rearward from the rear portion of the body portion 10. The work machine 1 moves the work field when the operator operates the operation handle 5.

The work machine 1 includes a container 60 that contains plants such as a mowed lawn and objects to be cut, and an attachment portion 13 provided on a rear surface of the body portion 10. The work machine 1 includes a height adjustment lever 34 that adjusts the height of the front wheels 2 and a height adjustment lever 38 that adjusts the height of the rear wheels 3.

An opening cover 14 that covers a downstream opening (not illustrated) of a passage 12 when the container 60 is removed is provided on the rear surface of the body portion 10.

A cutter blade 50 is provided that is rotated by an output shaft (not illustrated) extending substantially vertically downward from the engine 4. Furthermore, the body portion 10 includes a housing 11 that houses the cutter blade 50, a charging port 20 (illustrated by a broken line) through which the object to be cut or the like is charged, and a lid portion 22 that covers the charging port 20. Note that the power source that drives the output shaft is not limited to the engine 4, and may be, for example, a battery (including an electric motor) or a hybrid power source combining the engine 4 and the battery.

(Charging Port)

The housing 11 has a side surface 7 and an upper surface 9. The upper surface 9 refers to a surface substantially parallel to the ground. The side surface 7 refers to a surface extending substantially vertically with respect to the ground, and is a surface positioned at the periphery of the upper surface 9. The charging port 20 is a through hole provided on the upper surface 9. The operator charges the object to be cut to the cutter blade 50 through the charging port 20. The charging port 20 is provided in a flat portion of the upper surface 9 of the housing 11, but may be provided in an inclined portion of the upper surface 9. The shape of the charging port 20 is rectangular, but may be, for example, circular, elliptical, polygonal, or the like. In addition, the size of the charging port 20 may be a size corresponding to the size of the object to be cut. Note that the number of the charging ports 20 is one, but may be two or more.

Here, the object to be cut includes plants cut by the cutter blade 50, plants pulled out from the ground by the operator, plants cut by the operator using a mower, a lawn mower, a sickle, or the like, and plant bodies mainly including plants, lawns, and weeds. The plant bodies may further include, for example, thatch (cut lawn grass, leaves withered in winter, old roots of plants, and the like deposited on a surface layer or a shallow portion of soil to form a layer), a pruned branch, and a vegetable for disposal. The worker charges the object to be cut collected in the work field or the like into the charging port 20. Then, the object to be cut is chopped by the cutter blade 50.

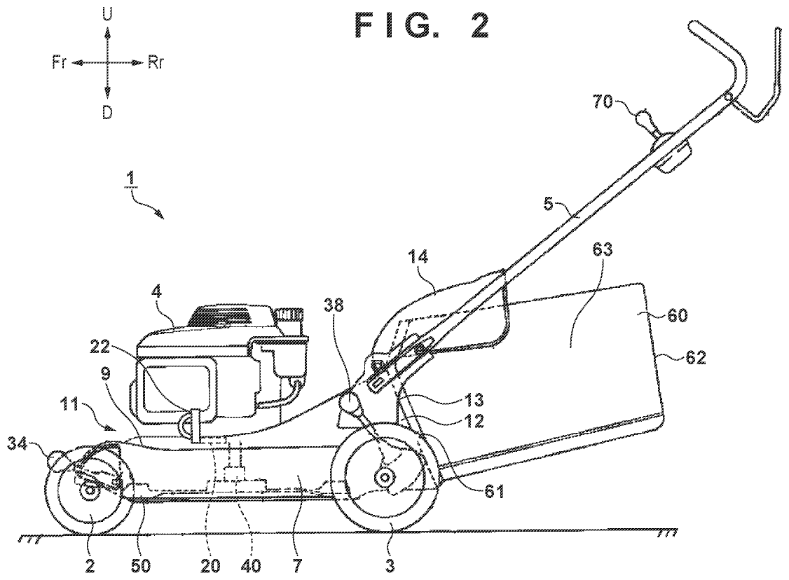

FIG. 2 is a side view of a work machine according to an embodiment of the present invention. An output shaft 40 that is rotated by the power of the engine 4 extends substantially vertically downward from the engine 4. At the lower end of the output shaft 40, a cutter blade 50 that rotates around the output shaft 40 to cut plants or the like is provided. Although FIG. 2 illustrates one cutter blade 50, two or more cutter blades 50 may be provided for one output shaft 40.

(Container)

The container 60 is, for example, a grass bag that contains plants cut by the cutter blade 50 or the like. The container 60 has a substantially rectangular parallelepiped shape that opens toward the rear surface of the body portion 10. The container 60 has an opening portion 61 that opens toward the rear surface of the body portion 10 and is connected to the attachment portion 13 provided on the rear surface of the body portion 10, an end surface 62 facing the opening portion 61, and a side surface 63 extending from the opening portion 61 to the end surface 62. Plants cut by the cutter blade 50 swirls in the housing 11 due to a swirling flow of the cutter blade 50, and is put into the container 60 through the passage 12.

(Height Adjustment of Cutter Blade)

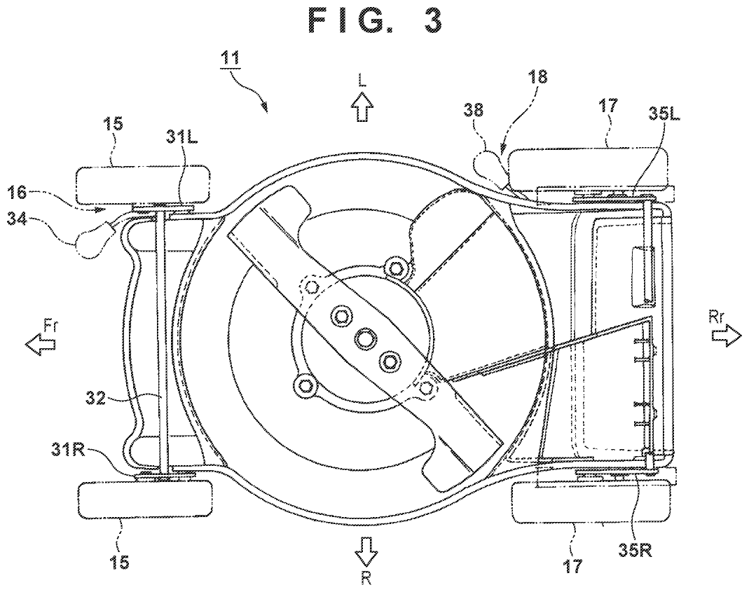

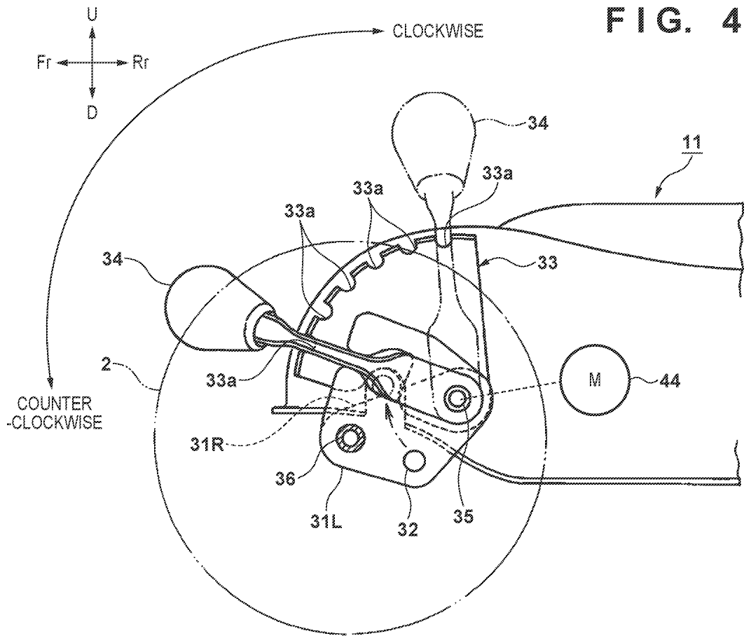

Here, height adjustment of the cutter blade 50 will be described with reference to FIGS. 3 to 4. The height of the cutter blade 50 refers to a height from the ground to the cutter blade 50. The height of the cutter blade 50 can be adjusted based on a known method (Japanese Patent Laid-Open No. 2002-065022 A).

FIG. 3 is a bottom view of a work machine according to an embodiment of the present invention. A left support member 31L and a right support member 31R are members that support the front wheel 2. A connecting member 32 is a member that connects the left support member 31L and the right support member 31R. The height adjustment lever 34 is a member that rotates the front wheel 2 with respect to a height adjustment plate 33 to be described later.

A left support member 35L and a right support member 35R are members that support the rear wheel 3. A connecting member (not illustrated) is a member that connects the left support member 35L and the right support member 35R. The height adjustment lever 38 is a member that rotates the rear wheel 3 with respect to a height adjustment plate 37 to be described later.

FIG. 4 is a left side view of a height adjustment mechanism of a work machine according to an embodiment of the present invention. A height adjustment mechanism 16 includes the left support member 31L and the right support member 31R that sandwich the housing 11, the connecting member 32 that connects the left support member 31L and the right support member 31R, a front wheel 2 rotatably attached to each of the ends of the left support member 31L and the right support member 31R (the front wheel 2 on the right side of the work machine 1 is not illustrated), the height adjustment plate 33 attached to the left side of the housing 11, and the height adjustment lever 34 connected to the left support member 31L. A support shaft 35 is a shaft that serves as a rotation center when the height adjustment lever 34 rotates. A motor 44 is connected to the support shaft 35, and can rotate the height adjustment lever 34 clockwise or counterclockwise (direction of an arrow in the figure). The height adjustment mechanism 16 is swingable around the support shaft 35 with respect to the housing 11. An axle 36 is attached to the left support member 31L.

Next, the movement of the height adjustment mechanism 16 will be described. By moving the height adjustment lever 34 clockwise or counterclockwise, the left support member 31L is interlocked with the height adjustment lever 34. At this time, since the right support member 31R is connected to the left support member 31L by the connecting member 32, the right support member 31R also moves in the same direction at the same time as the left support member 31L. The height of the front wheel 2 can be adjusted by fitting a protrusion (not illustrated) of the height adjustment lever 34 to a plurality of fitting portions 33a (illustrated as recesses) formed on the height adjustment plate 33.

For example, when the height adjustment lever 34 is fitted to the fitting portion 33a at the highest position of the height adjustment plate 33, the height from the ground to the cutter blade 50 is the maximum. On the other hand, when the height adjustment lever 34 is fitted to the fitting portion 33a at the lowest position of the height adjustment plate 33, the height from the ground to the cutter blade 50 is the minimum.

Here, the height adjustment mechanism 16 and a height adjustment mechanism 18 can be controlled by electronic control by an electronic control unit 70. For example, the electronic control unit 70 drives at least one of the height adjustment lever 34 and the height adjustment lever 38 by controlling the rotation speed of the motor 44. At least one of the height adjustment lever 34 and the height adjustment lever 38 may be manually adjusted by the operator. Since the height adjustment mechanism 18 for the rear wheel has the same configuration as the height adjustment mechanism 16 for the front wheel, the description thereof is omitted.

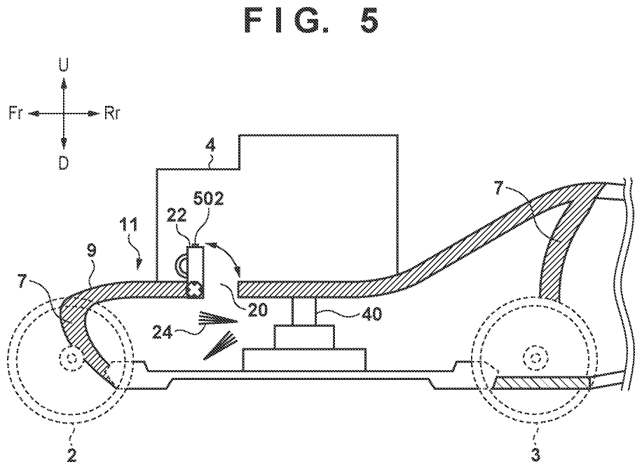

FIG. 5 is an enlarged cross-sectional view of a housing according to an embodiment of the present invention. FIG. 5 is a cross-sectional view taken along line A-A in FIG. 1. FIG. 5 illustrates only main components (front wheel 2, rear wheel 3, engine 4, housing 11, and the like) of the work machine 1 for simplification of description.

(Sensor Unit)

The lid portion 22 is a member capable of covering the charging port 20, and is, for example, a rectangular member having a hinge (illustrated with a cross). The lid portion 22 closes or opens the charging port 20 by rotating in the direction of an arrow around the hinge. In the lid portion 22, a handle or a knob is provided in an upper portion of the lid portion 22 in order to facilitate an operation of the lid portion 22 by the operator. Alternatively, the lid portion 22 may be a hingeless fitting member. In addition, the lid portion 22 includes a sensor unit 502 at an end portion in the lateral direction.

The sensor unit 502 is a sensor for detecting whether or not the lid portion 22 covers the charging port 20, and is, for example, a push switch, an optical sensor, or the like. When the lid portion 22 covers (closes) the charging port 20, the sensor unit 502 (for example, a switch) contacts a side wall of the charging port 20. At that time, the sensor unit 502 detects that the lid portion 22 covers the charging port 20 because the switch of the sensor unit 502 is pushed against the side wall of the charging port 20. On the other hand, when the lid portion 22 does not cover the charging port 20, the switch of the sensor unit 502 is not pushed against the side wall. Thus, the sensor unit 502 detects that the lid portion 22 does not cover the charging port 20. Alternatively, the sensor unit 502 may detect whether or not the charging port 20 is covered by the lid portion 22 based on a comparison between the illuminance received by the optical sensor and a threshold of the illuminance. The sensor unit 502 transmits a detection result related to a closing state of the charging port 20 acquired by the above detection method to the electronic control unit 70 described later.

(Hopper)

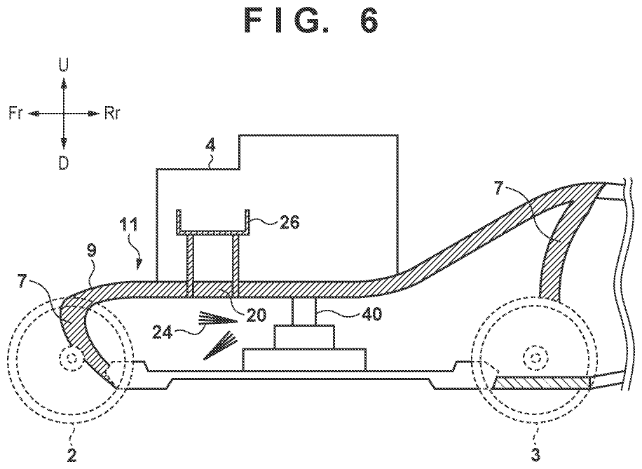

FIG. 6 is an enlarged cross-sectional view of a housing according to an embodiment of the present invention. FIG. 6 is a cross-sectional view taken along line A-A in FIG. 1. A hopper 26 may be connected to the charging port 20. The hopper 26 is detachable from the charging port 20. The hopper 26 is a member used by the operator to charge a large amount of an object to be cut 24 into the charging port 20, and is, for example, a resin hopper having a funnel shape. Note that the shape and material of the hopper 26 are not limited to the above. The shape of the hopper 26 may be, for example, a triangular pyramid or a cone. The material of the hopper 26 may be, for example, metal and ceramics.

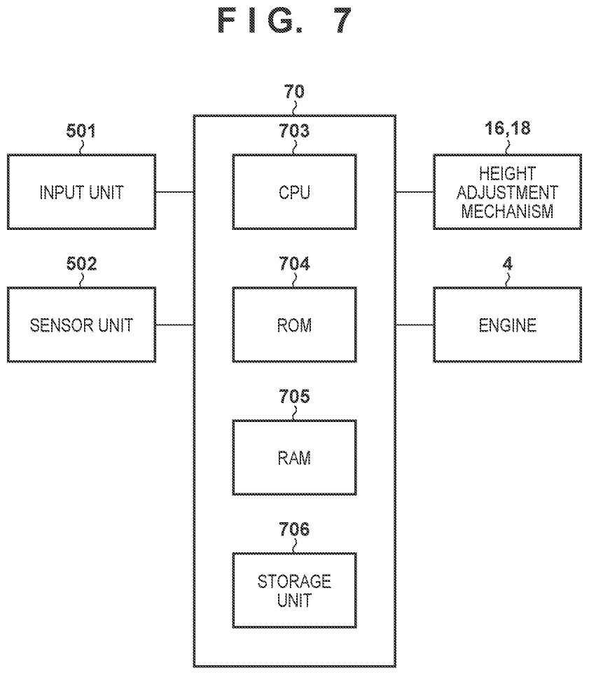

FIG. 7 is a block diagram illustrating a functional configuration of a work machine according to an embodiment of the present invention.

(Electronic Control Unit)

The work machine 1 includes the electronic control unit 70 that electronically controls each part of the work machine 1. The electronic control unit 70 is, for example, a microcomputer. The electronic control unit 70 includes a CPU 703, a ROM 704, a RAM 705, and a storage unit 706.

The CPU 703 is a processor that controls each part of the work machine 1, and performs various controls by executing a program stored in the ROM 704. For example, the CPU 703 controls the operations of the height adjustment mechanism 16, the height adjustment mechanism 18, and the engine 4 based on a control signal or the like from an input unit 501 and the sensor unit 502.

The ROM 704 stores a program for causing the CPU 703 to execute a predetermined operation. The predetermined operation refers to, for example, an operation of controlling at least one of the magnitude of the output of the engine 4, and the height adjustment mechanism 16 and the height adjustment mechanism 18.

The RAM 705 provides a work area for the CPU 703.

The storage unit 706 stores a program and various data for causing the CPU 703 to execute a predetermined operation. The storage unit 706 is, for example, a solid state drive (SSD) and a hard disk drive (HDD).

The input unit 501 is, for example, a user interface (UI) such as an operation button, a screen, and a touch panel provided on the operation handle 5. The input unit 501 receives an instruction to switch the magnitude of the output of the engine 4 from the operator via the operation button or the like. The instruction to switch the magnitude of the output of the engine 4 includes a “high speed mode” for an operation at a high output and a “normal mode” for an operation at a steady output. Note that the instruction to switch the magnitude of the output of the engine 4 may be a numerical value of the output (for example, target rotation speed (rpm)) of the engine 4 input by the operator via an operation dial, screen (not illustrated), or the like provided in the work machine 1.

The sensor unit 502 detects whether or not the charging port 20 is covered by the lid portion 22 using a certain type of sensor (for example, a switch, an optical sensor, or the like).

Hereinafter, the processing of the CPU 703 based on the control signals of the input unit 501 and the sensor unit 502 will be described.

The CPU 703 controls the height adjustment mechanism 16 and the height adjustment mechanism 18 based on a result received by the input unit 501. The result received by the input unit 501 refers to an instruction of either the “high speed mode” or the “normal mode”. For example, when the result received by the input unit 501 is the “high speed mode”, the CPU 703 controls at least one of the height adjustment mechanism 16 and the height adjustment mechanism 18 to raise the height from the ground to the cutter blade 50. On the other hand, for example, when the result received by the input unit 501 is the “normal mode”, the CPU 703 maintains the height from the ground to the cutter blade 50 without controlling the height adjustment mechanism 16 and the height adjustment mechanism 18. Alternatively, the result received by the input unit 501 may be a numerical value of the output of the engine 4.

The CPU 703 controls the magnitude of the output of the engine 4 based on the result received by the input unit 501. The result received by the input unit 501 refers to an instruction of either the “high speed mode” or the “normal mode”. For example, when the result received by the input unit 501 is the “high speed mode”, the CPU 703 performs control to increase the magnitude of the output of the engine 4. On the other hand, for example, when the result received by the input unit 501 is the “normal mode”, the CPU 703 performs control to maintain the magnitude of the output of the engine 4. Alternatively, the result received by the input unit 501 may be a numerical value of the output of the engine 4.

Furthermore, the CPU 703 controls the magnitude of the output of the engine 4 based on a detection result of the sensor unit 502. For example, when it is determined that the charging port 20 is not covered by the lid portion 22, the CPU 703 performs control to increase the magnitude of the output of the engine 4. On the other hand, when it is determined that the charging port 20 is covered by the lid portion 22, the CPU 703 performs control to maintain the magnitude of the output of the engine 4.

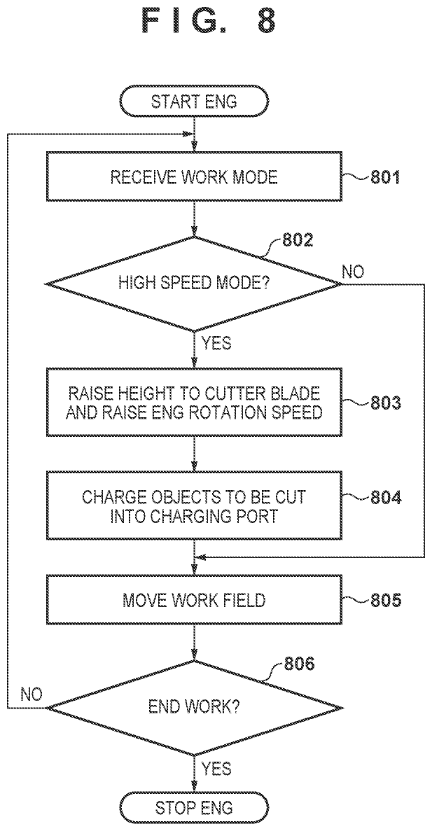

FIG. 8 is a flowchart for explaining an operation of the work machine based on selection of a work mode.

In S801, the input unit 501 receives the instruction to switch the magnitude of the output of the engine 4 from the operator via the operation dial, button, screen (not illustrated), or the like provided in the work machine 1.

In S802, the CPU 703 determines whether or not the reception result of the input unit 501 is the high speed mode. When the CPU 703 determines that the reception result of the input unit 501 is the high speed mode (Yes in S802), the processing proceeds to S803. On the other hand, when the CPU 703 determines that the reception result of the input unit 501 is not the high speed mode (No in S802), the processing proceeds to S805.

In S803, the CPU 703 controls the height adjustment mechanism 16 and the height adjustment mechanism 18 to raise the height from the ground to the cutter blade 50 based on height information included in the result received by the input unit 501. Here, the height information refers to, for example, a height from the ground to the cutter blade 50. In addition, the CPU 703 performs control to increase the magnitude of the output of the engine 4 based on the result received by the input unit 501. Here, the result received by the input unit 501 includes, for example, information on the target engine speed (rpm) of the engine 4.

In S804, the operator opens the lid portion 22 covering the charging port 20. Then, the operator charges a desired object to be cut into the charging port 20, and covers the charging port 20 with the lid portion 22.

In S805, the work machine 1 continues the work of cutting plants on the ground of the work field with the cutter blade 50.

In S806, the CPU 703 determines whether or not an instruction to end the work has been received based on information from the input unit 501. When the input unit 501 has received the instruction to end the work (Yes in S806), the CPU 703 performs control to stop the operation of the engine 4. On the other hand, when the input unit 501 has not received the instruction to end the work (No in S806), the processing returns to S801. Here, the instruction to end the work is, for example, an instruction to put the button of the ignition switch of the engine 4 into “OFF”.

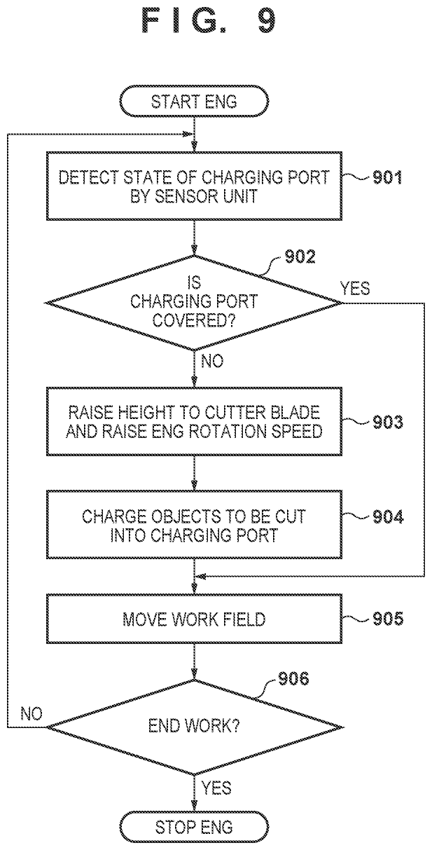

FIG. 9 is a flowchart for explaining an operation of the work machine based on the detection result of the sensor unit.

In S901, the sensor unit 502 detects whether or not the charging port 20 is covered by the lid portion 22 using a certain type of sensor (for example, a switch, an optical sensor, or the like).

In S902, the CPU 703 determines whether or not the charging port 20 is covered by the lid portion 22 based on the detection result by the sensor unit 502. When the CPU 703 determines that the charging port 20 is covered by the lid portion 22 based on the detection result by the sensor unit 502 in S902 (Yes in S902), the processing proceeds to S905. On the other hand, when the CPU 703 determines that the charging port 20 is not covered by the lid portion 22 based on the detection result by the sensor unit 502 in S902 (No in S902), the processing proceeds to S903.

In S903, the CPU 703 controls the height adjustment mechanism 16 and the height adjustment mechanism 18 to raise the height from the ground to the cutter blade 50 based on preset height information. In addition, the CPU 703 performs control to increase the magnitude of the output of the engine 4 based on the preset height information. The preset height information refers to a height from the ground to the cutter blade 50 set by the operator.

In S904, the operator opens the lid portion 22 covering the charging port 20. Then, the operator charges a desired object to be cut into the charging port 20, and covers the charging port 20 with the lid portion 22.

In S905, the work machine 1 continues the work of cutting plants on the ground of the work field with the cutter blade.

In S906, the CPU 703 determines whether or not the input unit 501 has received an instruction to end the work. When the input unit 501 has received the instruction to end the work (Yes in S906), the CPU 703 performs control to stop the operation of the engine 4. On the other hand, when the input unit 501 has not received the instruction to end the work (No in S906), the processing returns to S901. Here, the instruction to end the work is, for example, an instruction to put the button of the ignition switch of the engine 4 into “OFF”.

### SUMMARY OF EMBODIMENTS

The above-described embodiment at least discloses a work machine described as follows.
1. The work machine (1 in FIG. 1) of the above-described embodiment includes
a power source (4 in FIG. 1),
a rotation shaft (40 in FIG. 2)) that is rotated by power of the power source,
a cutter blade (50 in FIG. 1) that is rotated by the rotation shaft to cut a plant on the ground, and
a housing (11 in FIG. 1) that houses the cutter blade and has an opening through which the cutter blade is exposed to the ground,
wherein the housing (11 in FIG. 1) has a charging port (20 in FIG. 1) through which an object to be cut is charged to the cutter blade (50 in FIG. 1).

According to this embodiment, an object to be cut (plant bodies mainly including plants, lawns, and weeds, and the like) that is difficult to chop can be chopped.
2. The work machine (1 in FIG. 1) of the above-described embodiment further includes a lid portion (22 in FIG. 1) that covers the charging port (20 in FIG. 1).

According to this embodiment, cut plants are prevented from being released upward from the housing.
3. In the above-described embodiment, the housing (11 in FIG. 1) has a side surface (7 in FIG. 1) and an upper surface (9 in FIG. 1), and the charging port (20 in FIG. 1) is provided on the upper surface (9 in FIG. 1) of the housing.

According to this embodiment, the object to be cut can be charged to the cutter blade.
4. The work machine (1 in FIG. 1) of the above-described embodiment further includes
an input unit (501 in FIG. 7) to which an instruction to switch a magnitude of an output of the power source is input, and
a power control unit (70 in FIG. 7) configured to control the output of the power source (4 in FIG. 1) based on an input result input to the input unit (501 in FIG. 7).

According to this embodiment, the object to be cut can be chopped by rotating the cutter blade at a high speed.
5. The work machine (1 in FIG. 1) of the above-described embodiment further includes
a height control unit (70 in FIG. 7) configured to control a height from the ground to the cutter blade (50 in FIG. 1) based on the input result input to the input unit (501 in FIG. 7),
and the height control unit (70 in FIG. 7) performs control to raise the height from the ground to the cutter blade (50 in FIG. 1) in a case where the input result includes selection of increasing the output of the power source (4 in FIG. 1).

According to this embodiment, the object to be cut can be chopped while preventing unnecessary cutting of plants in the work field.
6. The work machine (1 in FIG. 1) of the above-described embodiment further includes
a sensor unit (502 in FIG. 7) configured to detect whether or not the charging port (20 in FIG. 1) is covered by a lid portion (22 in FIG. 1), and
the power control unit (70 in FIG. 7) performs control to increase the output of the power source (4 in FIG. 1) and raise the height from the ground to the cutter blade (50 in FIG. 1) in a case where it is determined that the charging port is not covered by the lid portion based on a detection result by the sensor unit.

According to this embodiment, it is possible to shift to the high speed mode in which the object to be cut is chopped without a work instruction from the operator.
7. In the above-described embodiment, the power control unit (70 in FIG. 7) performs control to reduce the output of the power source (4 in FIG. 1) and lower the height from the ground to the cutter blade (50 in FIG. 1) in a case where it is determined that the charging port (20 in FIG. 1) is covered by the lid portion (22 in FIG. 1) based on the detection result by the sensor unit (502 in FIG. 7).

According to this embodiment, it is possible to shift to the normal mode in which plants are cut without the work instruction from the operator.
8. The work machine (1 in FIG. 1) of the above-described embodiment further includes
a hopper (26 in FIG. 6) connected to the charging port (20 in FIG. 1).

According to this embodiment, the operator can charge a large amount of the objects to be cut into the charging port.
9. The work machine (1 in FIG. 1) of the above-described embodiment further includes
a body portion (10 in FIG. 1) having a passage through which a plant cut by the cutter blade (50 in FIG. 1) is carried out from the housing (11 in FIG. 1), and
a container (60 in FIG. 1) removably attached to the body portion and containing the plant.

According to this embodiment, it is possible to continue the cutting work of plants while containing cut plants.
10. The work machine (1 in FIG. 1) of the above-described embodiment further includes a wheel (2 and 3 in FIG. 1).

According to this embodiment, it is easy to move the work machine.
11. In the above-described embodiment, the object to be cut (24 in FIG. 5) is a plant body mainly including a plant, a lawn, and a weed.

According to this embodiment, various objects to be cut that are difficult to chop can be chopped.

The invention is not limited to the foregoing embodiments, and various variations/changes are possible within the spirit of the invention.

What is claimed is:

1. A work machine comprising:
a power source;
a rotation shaft that is rotated by power of the power source;
a cutter blade that is rotated by the rotation shaft to cut a plant on the ground; and
a housing that houses the cutter blade and has an opening through which the cutter blade is exposed to the ground,
wherein the housing has a charging port through which an object to be cut is charged to the cutter blade.

2. The work machine according to claim 1, further comprising
a lid portion that covers the charging port.

3. The work machine according to claim 1, wherein
the housing has a side surface and an upper surface, and
the charging port is provided on the upper surface of the housing.

4. The work machine according to claim 1, further comprising:
an input unit to which an instruction to switch a magnitude of an output of the power source is input; and
a power control unit configured to control the output of the power source based on an input result input to the input unit.

5. The work machine according to claim 4, further comprising
a height control unit configured to control a height from the ground to the cutter blade based on the input result input to the input unit,
wherein the height control unit performs control to raise the height from the ground to the cutter blade in a case where the input result includes selection of increasing the output of the power source.

6. The work machine according to claim 4, further comprising
a sensor unit configured to detect whether or not the charging port is covered by a lid portion,
wherein the power control unit performs control to increase the output of the power source and raise the height from the ground to the cutter blade in a case where it is determined that the charging port is not covered by the lid portion based on a detection result by the sensor unit.

7. The work machine according to claim 6, wherein
the power control unit performs control to reduce the output of the power source and lower the height from the ground to the cutter blade in a case where it is determined that the charging port is covered by the lid portion based on the detection result by the sensor unit.

8. The work machine according to claim 1, further comprising
a hopper connected to the charging port.

9. The work machine according to claim 1, further comprising:
a body portion having a passage through which a plant cut by the cutter blade is carried out from the housing; and
a container removably attached to the body portion and containing the plant.

10. The work machine according to claim 1 further comprising
a wheel.

11. The work machine according to claim 1, wherein
the object to be cut is a plant body mainly including a plant, a lawn, and a weed.
